(19) United States
(12) Patent Application Publication
(10) Pub. No.: US 2022/0052362 A1
(43) Pub. Date: Feb. 17, 2022

(54) FUEL CELL ACTIVATION METHOD AND APPARATUS

(71) Applicant: HONDA MOTOR CO., LTD., Tokyo (JP)

(72) Inventors: Hodaka TSUGE, Tochigi (JP); Ryo UOZUMI, Tochigi (JP)

(21) Appl. No.: 17/417,103

(22) PCT Filed: Dec. 26, 2019
(86) PCT No.: PCT/JP2019/051244

§ 371 Date: Jun. 21, 2021

(30) Foreign Application Priority Data
Dec. 26, 2018 (JP) 2018-243307

(51) Int. Cl. H01M 8/04225; H01M 8/04119; H01M 8/04858; H01M 8/04537; H01M 8/04701

(52) U.S. Cl. CPC H01M 8/04225; H01M 8/04126; H01M 2008/1095; H01M 8/04559; H01M 8/04708; H01M 8/0491

(57) ABSTRACT

This fuel cell stack activation method is a method for activating a fuel cell stack provided with a solid polymer-containing electrolyte membrane, an anode electrode, and a cathode electrode, the method comprising: a first current application step for applying a current by electrically connecting the two electrodes via an external electrical load in a state in which a potential difference is generated between the two electrodes by supplying air as a cathode-side gas to the cathode electrode while supplying hydrogen gas as an anode-side gas to the anode electrode; and a second current application step for applying a current by electrically connecting the two electrodes via an external electrical load in a state in which a potential difference is generated between the two electrodes by supplying nitrogen gas as a cathode-side gas to die cathode electrode while supplying hydrogen gas as an anode-side gas to the anode electrode.

### TECHNICAL FIELD

The present invention relates to a fuel cell activation method and activation apparatus. In more detail, it relates to an activation method and activation apparatus for a fuel cell including an electrolyte layer containing a solid polymer, and an anode electrode and cathode electrode provided on faces on both sides of this electrolyte layer.

### BACKGROUND ART

The fuel battery cell is formed by sandwiching an electrolyte membrane/electrode structure (so-called MEA) formed by arranging the electrolyte layer containing solid polymer between the anode electrode and cathode electrode, by a pair of separators. In addition, the fuel cell stack is formed by laminating a plurality of such fuel battery cells, and is equipped as the power source of a vehicle, for example.

The power generation performance immediately after assembly of the above such fuel cell and fuel cell stack (unless necessary to distinguish between cell and stack, these are simply referred to as “fuel cell”) is low. For this reason, various activation processing (aging) is performed in order to raise this power generation performance after assembling the fuel cell.

For example, with the activation method of fuel cell disclosed in Patent Document 1, in the activation apparatus in which the anode electrode and cathode electrode of a fuel cell are connected via a switching element and resistive element, a first step of supplying hydrogen gas to the anode electrode while opening the switching element, and supplying air to the cathode electrode, and a second step of closing the switching element to stop the supply of air to the cathode electrode are alternately repeated.

Patent Document 1: Japanese Unexamined Patent Application, Publication No. 200-267455

### DISCLOSURE OF THE INVENTION

### Problems to be Solved by the Invention

With the activation method described in Patent Document 1, although the fuel cell can be activated by a simple activation apparatus, since hydrogen cross leaks from the anode electrode to the cathode electrode when stopping the supply of air in the second step, and the potential difference between the anode electrode and cathode electrode will, become small, there is a risk of the aging effect lowering, and more time being required in activation. In addition, when transitioning from the second step to the first step, and resuming the supply of air to the cathode electrode, the hydrogen remaining in the cathode electrode and oxygen in the air newly supplied to the cathode electrode may react directly, and there is a risk of the fuel cell deteriorating due to heat generation.

The present invention has an object of providing an activation method and activation apparatus which can activate in a short time while suppressing deterioration of the fuel cell.

### Means for Solving the Problems

An activation method for a fuel cell (for example, the fuel battery cell 2 and fuel cell stack 1 described later) according to a first aspect of the present invention is a method for activating a fuel cell including: an electrolyte layer (for example, the electrolyte membrane 24 described later) containing solid polymer, an anode electrode (for example, the anode electrode 25 described later) provided to one surface of the electrolyte layer, and a cathode electrode (for example, the cathode electrode 26 described later) provided to another surface of the electrolyte layer, the activation method including: a first current application step of electrically connecting the anode electrode and the cathode electrode via an external electrical load to apply current, in a state of generating a potential difference between the anode electrode and the cathode electrode, by supplying hydrogen gas as anode-side gas to the anode electrode and supplying oxidizer gas as cathode-side gas to the cathode electrode; and a second current application step of electrically connecting the anode electrode and the cathode electrode via the external electrical load (for example, the external electrical load 6 described later) to apply current, in a state of generating a potential difference between the anode electrode and the cathode electrode, by supplying hydrogen gas as anode-side gas to the anode electrode and supplying inert gas as cathode-side gas to the cathode electrode.

According to a second aspect of the present invention. In this case, it is preferable to alternately repeatedly perform for a plurality of time the first current application step and the second current application step.

According to a third aspect of the present invention, in this case, it is preferable for the first current application step to supply a mixture mixing oxidizer gas and inert gas to the cathode electrode as cathode-side gas; and supply of oxidizer gas to be turned OFF while continuing supply of inert gas when transitioning from the first current application step to the second current application step.

According to a fourth aspect of the present invention, in this case, it is preferable after a state in which a potential difference between the anode electrode and the cathode electrode is no more than a predetermined voltage continues for a predetermined time while performing the second current application step, to transition from the second current application step to the first current application step.

An activation apparatus (for example, the activation apparatus 3 described later) for a fuel cell (for example, the fuel, battery cell 2 and fuel cell stack 1 described later) according to a fifth aspect of the present invention is an apparatus for activating a fuel cell including: an electrolyte layer (for example, the electroyte membrane 24 described later) containing solid polymer, an anode electrode (for example, the anode electrode 25 described later) provided to one surface of the electrolyte layer, and a cathode electrode (for example, the cathode electrode 26 described later) provided to another surface of the electrolyte layer, the activation apparatus including: an external electrical load (for example, the external electrical load 6 described later) which electrically connects the anode electrode and the cathode electrode; a hydrogen gas supply source (for example, the hydrogen gas supply source 41 described later) which supplies hydrogen gas; an anode-side gas supply path (for example, the hydrogen gas supply path 42 described later) which connects the anode electrode and the hydrogen gas supply source; an oxidizer gas supply source (for example, the air pump 51 described later) which supplies oxidizer gas; an inert gas supply source (for example, the nitrogen gas supply source 52 described later) which supplies inert gas; a cathode-side gas supply path (for example, the cathode-side gas supply path 54 described later) which connects the cathode electrode with the oxidizer gas supply source and the inert gas supply source; and a control means (for example, the control device 53 described later) which alternately turns ON or OFF supply of oxidizer gas from the oxidizer gas supply source to the cathode electrode.

According to a sixth aspect of the present invention, in this case, it is preferable for the activation apparatus to further include a voltage sensor (For example, the cell voltage sensor 7 described later) which detects a potential difference between the anode electrode and the cathode electrode, in which the control means which turns ON supply of the oxidizer gas, after a state in which the potential difference when turning OFF supply of the oxidizer gas declined to no more than a predetermined voltage has continued for a predetermined time.

### Effects of the Invention

(1) The activation method of the present invention activates a fuel cell by executing the first current application step of electrically connecting both electrodes in a state producing a potential difference by supplying hydrogen gas to the anode electrode and supplying oxidizer gas to the cathode electrode, via the external electrical load, and applying current; and the second current application step of electrically connecting both electrodes in a state producing a potential difference between both electrodes by supplying hydrogen gas to the anode electrode and supplying inert gas to the cathode electrode, via the external electrical load, and applying current. According to the activation method of the present invention, it is thereby possible to activate the fuel cell in a short time while suppressing deterioration of the fuel cell, compared to the activation method described in Patent Document 1 which continuously supplies air to the cathode electrode (hereinafter also referred to as “conventional activation method”).

Herein, the second current application step can produce a potential difference between both electrodes using the hydrogen concentration difference between the anode electrode supplied hydrogen gas and the cathode electrode supplied inert gas, and makes it possible to perform current application of both electrodes at lower electrical current and smaller supply amounts of anode-side gas and cathode-side gas than during normal power generation, by electrically connecting both electrodes via the external electrical load in a state in which a potential difference occurs in this way. In addition, in the second current application step, since it is possible to supply generated hydrogen produced by electrode reaction by the hydrogen concentration cell to the electrode catalyst and electrolyte membrane included in the anode electrode and cathode electrode, it is possible to generate good proton conductivity with the electrolyte layer in a wet state, and supply to the three-phase interface of the electrode catalyst, electrolyte layer and hydrogen gas or oxidizer gas, which is the reaction site during power generation of the fuel cell, and consequently efficiently activate the fuel cell.

Herein, since a hydrogen concentration cell difference is produced between both electrodes when stopping the supply of oxidizer gas to the cathode electrode also in the conventional activation method, it is possible to activate the fuel cell. However, with the conventional activation method, hydrogen gas which has cross leaked from the anode electrode remains when stopping the supply of oxidizer gas to the cathode electrode, and the potential difference between both electrodes becomes smaller; therefore, the activation effect gradually decreases. In addition, after stopping the supply of oxidizer gas, when supplying oxidizer gas again, since the hydrogen remaining in the cathode electrode and oxidizer gas will directly react, heat will generate, and there is a risk of the fuel cell deteriorating. In contrast, in the activation method of the present invention, since cross leaking from the anode electrode can be suppressed by supplying inert gas in the second current application step, the hydrogen concentration difference can be maintained high, and consequently, a high activation effect can be maintained. In addition, since it is possible to suppress cross leaking in this way with the activation method of the present invention, direct reaction between oxidizer gas and hydrogen can be suppressed, and consequently, deterioration of the fuel cell can also be suppressed. Consequently, according to the activation method of the present invention, it is possible to activate the fuel cell in a short time compared to a conventional activation method, while suppressing deterioration of the fuel cell.

(2) By repeatedly performing a plurality of times the first current application step and second current application step alternately, the activation method of the present invention can rapidly activate a fuel cell compared to the case of performing both steps once each.

(3) In the activation method of the present invention, the first current application step supplies a gas made by mixing oxidizer gas and inert gas to the cathode electrode as cathode-side gas, and turns ON the supply of oxidizer gas while continuing the supply of inert gas, upon transitioning from the first current application step to the second current application step. Therefore, in the activation method of the present invention, since it is possible to repeatedly perform a plurality of times the first current application step and second current application step alternately, by simply alternately repeating ON and OFF of the supply of oxidizer gas, it is possible to activate the fuel cell with a simple configuration.

(4) When transitioning from the first current application step to the second current application step, the potential difference between the anode electrode and cathode electrode gradually declines immediately after transition due to the oxidizer gas remaining in the cathode electrode gradually decreasing. Subsequently, when there is no longer oxidizer gas remaining in the cathode electrode, the fuel cell becomes a hydrogen concentration cell, and the potential difference between both cells is maintained at a predetermined voltage greater than 0. In contrast, with the activation method of the present invention, by transitioning from the second current application step to the first current application step after a state in which a potential difference between both electrodes is no more than a predetermined voltage continued for a predetermined time while performing the second current application step, since it is possible to establish the fuel cell as a hydrogen concentration cell over a suitable time, the fuel cell can be efficiently activated.

(5) The activation apparatus of the present invention includes the external electrical load which electrically connects the anode electrode and cathode electrode; and the control means which alternately turns ON or OFF the supply of oxidizer gas to the cathode electrode from the oxidizer gas supply source and the cathode-side gas supply path which connects the cathode electrode with the oxidizer gas supply source and inert gas supply source. According to the activation apparatus of the present invention, by alternately turning ON or OFF the supply of oxidizer gas by the control means, since it is thereby possible to repeatedly perform over a plurality of times the aforementioned first current application step and second current application step alternately, the fuel cell can be efficiently activated while suppressing deterioration of the fuel cell in the aforementioned way.

(6) The control means in the activation apparatus of the present invention turns ON the supply of oxidizer gas, after a state in which potential difference has declined to no more than a predetermined voltage when turning OFF the supply of oxidizer gas has continued for a predetermined time. Since it is thereby possible to establish the fuel cell as a hydrogen concentration cell over an appropriate time, the fuel cell can be efficiently activated.

### BRIEF DESCRIPTION OF THE DRAWINGS

FIG. 1 is a view showing the configurations of a fuel cell stack and activation apparatus thereof according to an embodiment of the present invention;

FIG. 2 is a flowchart showing a specific sequence of the activation method according to the embodiment of the present invention; and

FIG. 3 is a graph showing an example of change in cell average voltage of a fuel cell stack in the case of executing a first current application step after executing a second current application step.

### PREFERRED MODE FOR CARRYING OUT THE INVENTION

Hereinafter, the configuration of an activation apparatus 3 of a fuel cell stack 1 according to an embodiment of the present invention, and a sequence of an activation method for activating the fuel cell stack 1 using this activation apparatus 3 will be explained in detail while referencing the drawings.

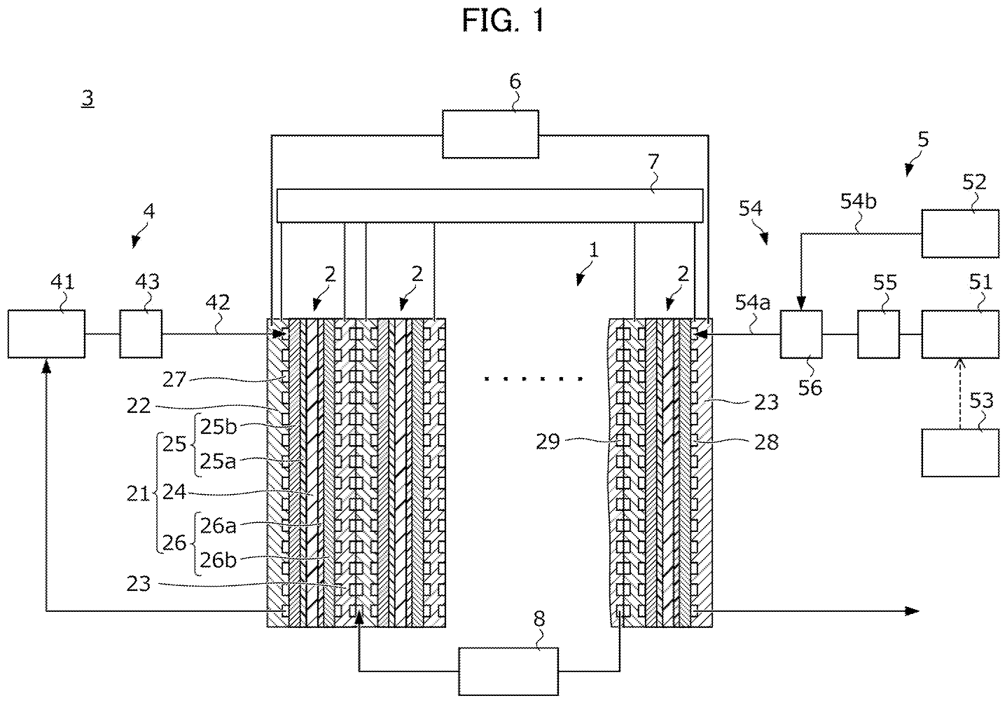

FIG. 1 is a view showing the configurations of the fuel cell stack 1 and the activation apparatus 3 thereof. The fuel cell stack 1 is configured by laminating a plurality of fuel battery cells 2. FIG. 1 illustrates only a part of the plurality of fuel battery cells 2. It should be noted that, hereinafter, although a case of activating the fuel cell stack 1 is explained, the present invention is not limited thereto. The present invention may activate each fuel battery cell 2 constituting the fuel cell stack 1.

The fuel battery cell 2 includes: an electrolyte membrane/electrode structure 21 (hereinafter referred to as “MEA 21”), and a first separator 22 and second separator 23 sandwiching this MEA 21. The MEA 21 includes the electrolyte film 24 as the electrolyte layer containing a solid polymer such as a perfluorosulfonic acid thin film, the anode electrode 25 provided on one side of this electrolyte film 24, and the cathode electrode 26 provided on the other side of the electrolyte film 24.

The anode electrode 25 is a porous body including a first electrode catalyst layer 25a meeting one side of the electrolyte film 24, and a first gas diffusion layer 25b laminated on the first electrode catalyst layer 25a. The cathode electrode 26 is a porous body including a second electrode catalyst layer 26a meeting the other side of the electrolyte film 24, and a second gas diffusion layer 26b laminated on the second electrode catalyst layer 26a.

The first electrode catalyst layer 25a and second electrode catalyst layer 26a include catalyst particles (electrode catalyst) constituted by loading a catalytic metal such as platinum on a catalyst support made of carbon such as carbon black, and ion conductive polymer binder, for example. It should be noted that the above-mentioned electrode catalyst consists of only the catalyst metal such as platinum black, for example, and may not necessarily contain a catalyst support.

In the case of the electrode catalyst consisting of platinum, the electrode reaction such as 2Pt+H₂O+1/2O₂+e″ →2Pt (OH⁻), Pt (OH⁻)+H₃O⁺→Pt+2H₂O, for example, occurs at the surface of this electrode catalyst. This electrode reaction is promoted by supplying water to the surface of the electrode catalyst, and having water exist at the three-phase interface. Three-phase interface is the interface of the hydrogen gas or oxidizer gas with the electrode catalyst and the electrolyte film 24 serving as the reaction site, during actual power generation of the fuel cell stack 1. It should be noted that, during actual power generation of the fuel cell stack 1 indicates when supplying anode-side gas containing hydrogen gas to the anode electrode 25, and supplying cathode-side gas containing oxidizer gas to the cathode electrode 26, to actually obtain electric power from the fuel cell stack 1.

The first gas diffusion layer 25b and second gas diffusion layer 26b, for example, consist of carbon paper, carbon cloth or the like. The first gas diffusion layer 25b is arranged so as to meet the first separator 22, and the second gas diffusion layer 26b is arranged so as to meet the second separator 23. As the first separator 22 and second separator 23, for example, a carbon separator is used; however, a metal separator may be used in place thereof.

At the surface of the first separator 22 meeting the first gas diffusion layer 25b, an anode-side gas channel 27 is formed which communicates the anode-side gas inlet communication hole (not shown) for supplying anode-side gas, and anode-side gas outlet communication hole (not shown) for discharging this anode-side gas.

At the surface of the second separator 23 meeting the second gas diffusion layer 26b, an cathode-side gas channel 28 is formed which communicates the cathode-side gas inlet communication hole (not shown) for supplying cathode-side gas, and cathode-side gas outlet communication hole (not shown) for discharging this cathode-side gas.

In addition, between opposing surfaces of the first separator 22 and second separator 23 of each fuel battery cell 2 in the fuel cell stack 1, a coolant channel 29 is integrally formed which communicates a cooling medium inlet communication hole (not shown) for supplying cooling medium, and a cooling medium output communication hole (not shown) for discharging this cooling medium.

The activation apparatus 3 includes: an anode-side gas supply device 4 which supplies anode-side gas to the anode-side gas channel 27 of the fuel cell stack 1; a cathode-side gas supply device 5 which supplies cathode-side gas to the cathode-side gas channel 28 of the fuel cell stack 1; an external electrical load 6 which electrically connects the anode electrode 25 and cathode electrode 26 of the fuel cell stack 1; a cell voltage sensor and a temperature regulation device 8 which adjusts the temperature of the fuel cell stack 1.

An external electrical load 6 electrically connects with the anode electrode 25 and cathode electrode 26 of the fuel cell stack 1, and applies current between both electrodes 25, 26. The external electrical load 6 flows electrical current from the cathode electrode 26 to the anode electrode 25, when the electrical potential occurs between this anode electrode 25 and cathode electrode 26, by supplying anode-side gas to the anode electrode 25 from an anode-side gas supply device 4, and supplying cathode-side gas to the cathode electrode 26 from a cathode-side gas supply device 5. With this external electrical load 6, it becomes possible to maintain the electrical current applied between both electrodes 25, 26 at a predetermined magnitude.

A cell voltage sensor 7 detects the cell voltage generated between the anode electrode 25 and cathode electrode 26 at every fuel battery cell 2, and sends a detection signal according to the magnitude of this cell voltage to a control device 53 described later of the cathode-side gas supply device 5. The cell average voltage which is the average of the cell voltage of each fuel battery cell 2 is calculated by the control device 53 based on the detection signal from this cell voltage sensor 7.

A temperature regulation device 8 adjusts the temperature of the fuel cell stack 1, by supplying heating medium regulated to a predetermined temperature to the coolant channel 29 of the fuel cell stack 1.

The anode-side gas supply device 4 supplies the anode-side gas containing hydrogen gas to the anode-side gas channel 27. The anode-side gas supply device 4 includes: a hydrogen gas supply source 41 supplying hydrogen gas, a hydrogen gas supply path 42 connecting the hydrogen gas supply source 41 and anode-side gas channel 27, and an anode-side humidifier 43 provided to this hydrogen gas supply path 42. The hydrogen gas supply source 41 is configured by a hydrogen gas tank (not shown) which stores hydrogen gas at high pressure, a flowrate regulating valve (not shown), which regulates the flowrate of hydrogen gas supplied to the hydrogen gas supply path 42 from this hydrogen gas tank, etc. The hydrogen gas supply path 42 is a pipe connecting the hydrogen gas supply source 41 and anode-side gas channel 27, and leads the hydrogen gas supplied from the hydrogen gas supply source 41 to the anode-side gas channel 27. The anode-side humidifier 43 mixes the hydrogen gas supplied from the hydrogen gas supply source 41 and water vapor, and adjusts the dew point of the anode-side gas. The anode-side gas supply device 4 supplies, to the anode-side gas channel 27 at a predetermined flowrate, the anode-side gas adjusted to a predetermined dew point, by using this hydrogen gas supply source 41, hydrogen gas supply path 42 and anode-side humidifier 43.

The cathode-side gas supply device 5 supplies, to the cathode-side gas channel 28, air as an oxidizer gas and the cathode-side gas containing nitrogen gas as an inert gas. The cathode-side gas supply device 5 includes: an air pump 51 which supplies air; nitrogen gas supply source 52 which supplies nitrogen gas; control device 53 which controls this air pump 51; cathode-side gas supply path 54 which connects this air pump 51, nitrogen gas supply source 52 and cathode-side gas supply 28; and cathode-side humidifier 55 and mixer 56 provided to this cathode-side gas supply path 54.

The cathode-side gas supply path 54 includes a first channel 54a which connects the air pump 51 and cathode-side gas channel 28, and a second channel 54b which connects the nitrogen gas supply source 52 and first channel 54a.

The air pump 51 compresses air according to a command from the control device 53, and supplies the compressed air to the cathode-side gas channel 28 via the first channel 54a. The control device 53 adjusts the flowrate of air supplied to the first channel 54a, by controlling the revolution speed of the air pump 51. The control device 53 enables alternately turning ON or OFF the supply of air to the cathode-side gas channel 28 from the air pump 51. It should be noted that the present embodiment explains a case of alternately turning ON or OFF the supply of air to the cathode-side gas channel 28 from the air supply source, by controlling the revolution speed of the air pump 51 by the control device 53; however, the present Invention is not limited thereto, in the case of a flowrate control valve being provided in the channel of air connecting the air supply source and cathode-side gas channel 28, the supply of air from the air supply source to the cathode-side gas channel 28 may be alternately turned ON or OFF by controlling the aperture of this flowrate control valve.

The nitrogen gas supply source 52 is configured by a nitrogen gas tank (not shown) which stores nitrogen gas at high pressure, a flowrate regulating valve (not shown) which adjusts the flowrate of nitrogen gas supplied from this nitrogen tank to the second channel 54b.

The cathode-side humidifier 55 is provided to the first channel 54a, mixes the air supplied from the air pump 51 and water vapor, and adjusts the dev point of air flowing in the first channel 54a. The mixer 56 is provided more to the side of the cathode-side gas channel 28 than the cathode-side humidifier 55 in the first channel 54a. The mixer 50 mixes the air supplied from the air pump 51 via the first channel 54a and the nitrogen gas supplied from the nitrogen gas supply source 52 via the second channel 54b, and supplies to the cathode-side gas channel 28. The cathode-side gas supply device 5 supplies the cathode-side gas adjusted to the predetermined dew point to the cathode-side gas channel 28 at a predetermined flowrate, by using this air pump 51, nitrogen gas supply source 52, control device 53, cathode-side gas supply path 54, cathode-side humidifier 55 and mixer 56.

Next, a specific sequence of an activation method for activating the fuel cell stack 1 using the above such activation device 3 will be explained.

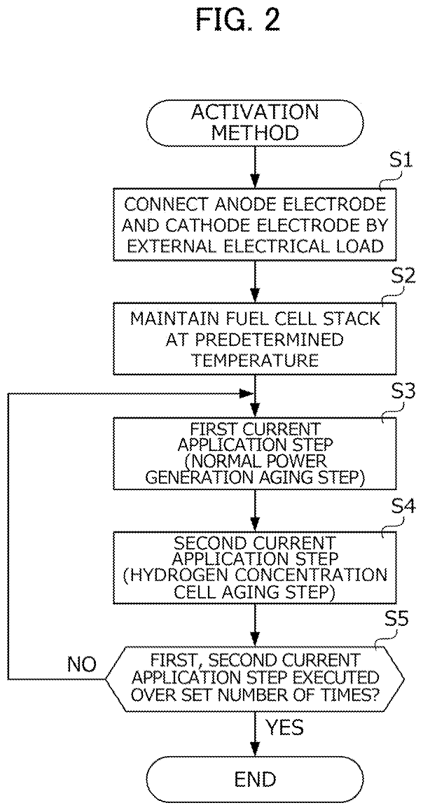

FIG. 2 is a flowchart showing the specific sequence of the activation method according to the present embodiment. First, in Step S1, the anode electrode 25 and cathode electrode 26 of the fuel cell stack 1 are electrically connected by the external electrical load 6. Next, in Step S2, the fuel cell stack 1 is maintained at a predetermined temperature, by supplying the heating medium adjusted to the predetermined temperature to the coolant channel 29 of the fuel cell stack 1 by the temperature regulation device 8.

In Step S3, the first current application step is executed for a predetermined tine. In this first current application step, a potential difference is produced between the anode electrode 25 and cathode electrode 26, and current is applied between these electrodes 25, 26 via the external electrical load 6, by supplying anode-side gas to the anode-side gas channel 27 from the anode-side gas supply device 4, and supplying cathode-side gas to the cathode-side gas channel 28 from the cathode-side gas supply device 5. In this first current application step, the anode-side gas supply device 4 supplies the anode-side gas adjusted to a predetermined dew point to the anode-side gas channel 27 at a predetermined flowrate, by mixing hydrogen gas and water vapor. In addition, in this first current application step, the cathode-side gas supply device 5 supplies, to the cathode-side gas channel 28 as cathode-side gas, a gas made by mixing the air adjusted to a predetermined dew point and predetermined flowrate and nitrogen gas adjusted to a predetermined flowrate. It should be noted that, in this first current application step, the anode-side gas supply device 4 and cathode-side supply device 5 supply the anode-side gas and cathode-side gas so that the pressure difference between the anode-side gas channel 27 and cathode-side gas channel 28 is maintained at a predetermined value.

In the above way, the first current application step is a so-called normal power generation aging step of prompting activation of the fuel cell stack 1, by supplying the anode-side gas containing hydrogen gas to the anode electrode 25, and supplying the cathode-side gas containing oxidizer gas to the cathode electrode 26 to carry out normal power generation by the fuel cell stack 1.

Next, in Step S4, the second current application step is executed over a predetermined time. In this second current application step, a potential difference is produced between the anode electrode 25 and cathode electrode 26 to apply current between these electrodes 25, 26 via the external electrical load 6, by supplying the anode-side gas to the anode-side gas channel 27 from the anode-side gas supply device 4, and supplying cathode-side gas of a component different than the aforementioned first current application step to the cathode-side gas channel 23 from the cathode-side gas supply device 5.

Herein, the flowrate ratio (flowrate of air/flowrate of nitrogen gas) of air to nitrogen gas in the cathode-side gas supplying the cathode-side gas channel 28 is set so that the second current application step is smaller than the first current application step. As explained by referencing Example 4 later, it is possible to realize more efficient activation as lessening the flowrate ratio of air to nitrogen gas of the cathode-side gas in the second current application step. For this reason, hereinafter, a case is explained of setting the flowrate ratio of air to nitrogen gas of the cathode-side gas supplied to the cathode-side gas channel 28 in the second current application step to 0 (i.e. case of turning OFF the supply of air in the second current application step); however, the present invention is not limited thereto.

In this second current application step, the anode-side gas supply device 4 supplies the anode-side gas adjusted to a predetermined dew point by mixing the hydrogen gas and water vapor to the anode-side gas channel 27 at a predetermined flowrate. It should be rioted that the flowrate and/or dew point of the anode-side gas in the second current application step preferably equals the first current application step. For this reason, upon repeatedly executing the first current application step and second current application step alternately, it is preferable to continually supply anode-side gas adjusted to the predetermined dew point at a fixed flowrate to the anode-side gas channel 27.

In addition, in the second current application step, the cathode-side gas supply device 5 supplies the nitrogen gas adjusted to the predetermined flowrate to the cathode-side gas channel 28 as the cathode-side gas. It should be noted that the flowrate of nitrogen gas in the second current application step preferably equals the flowrate of nitrogen gas in the first current application step. For this reason, upon repeatedly executing the first current application step and second current application step alternately, it is preferable to continually supply nitrogen gas at a fixed flowrate to the cathode-side gas channel 28 from the nitrogen gas supply source 52. In addition, when transitioning to the second current application step from the first current application step, it is preferable to turn OFF the supply of air from the air pump 51 by the control device 53, while continually supplying nitrogen gas at a fixed flowrate in the aforementioned way. In addition, when transitioning to the first current application step from the second current application step, it is preferable to turn ON the supply of air from the air pump 51 by the control device 53. It should be noted that, in this second current application step, the anode-side gas supply device 4 and cathode-side gas supply device 5 supply the anode-side gas and cathode-side gas so that the pressure difference between the anode-side gas channel 27 and cathode-side gas channel 28 is maintained at a predetermined value, similarly to the first current application step.

In the above way, the second current application step is a so-called hydrogen concentration cell aging step of promoting activation of the fuel cell stack 1 by supplying anode-side gas containing hydrogen gas to the anode electrode 25 and supplying cathode-side gas containing inert gas but not containing oxidizer gas to the cathode electrode 26, to produce a hydrogen concentration difference between both electrodes 25, 26, and using the fuel cell stack 1 as a hydrogen concentration cell.

Next, in Step S5, it is determined whether to repeatedly execute the first current application step and second current application step over a predetermined setting number. In the case of the determination result of Step S5 being NO, the processing returns to Step S3, and the first current application step and second current application step are executed again. In the case of the determination result of Step S6 being YES, the activation method of FIG. 2 is ended. It should be noted that, in order to efficiently activate the fuel cell stack 1, the setting number is set to an integer of at least 2, and it is preferable to repeatedly perform a plurality of times the first current application step and second current application step alternately.

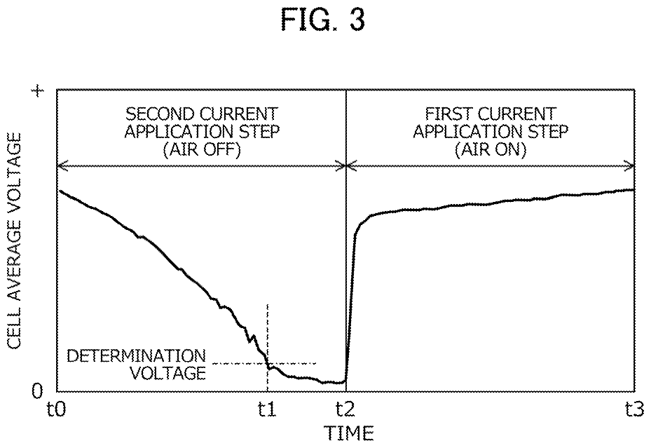

FIG. 3 is a graph showing an example of change in cell average voltage of the fuel cell, stack 1 in the case of executing the second current application step, and then executing the first current application step. More specifically, FIG. 3 is a graph showing an example of change in the cell average voltage in the case of activating the fuel cell stack 1 by Example 1 described later. FIG. 3 shows a case of transitioning to the first current application step from the second current application step at time t2, after executing the first current application step until time t0, and then transitioning from the first current application step to the second current application step at time t0, and ending the first current application step at time t3. At this time, when the cell average voltage detected by the cell voltage sensor 7 becomes no more than a predetermined determination voltage while performing the second current application step, the control device 53 may change so as to decrease to a value smaller than the current consumption by the external electrical load of the first current application step (more specifically, value somewhat greater than 0).

As shown in FIG. 3, when turning OFF the supply of air to the fuel cell stack 1 accompanying transitioning from the first emerging step to the second current application step at time t0, the oxygen concentration of the cathode electrode 26 declines, and the cell average voltage gradually declines. Subsequently, when oxygen remaining the cathode-side gas channel 26 at time t1 is exhausted by power generation, and the gas in the cathode-side gas channel 28 is replaced by nitrogen gas, the fuel cell stack 1 becomes a hydrogen concentration cell. For this reason, at times t1 and later, a state in which the cell average voltage is higher than 0 V is maintained. Subsequently, when turning ON the supply of air to the fuel cell stack 1 accompanying transitioning from the second current application step to the first current application step at time t2, since the normal power generation is performed by the fuel cell stack 1, the cell average voltage recovers. At this time, when the cell average voltage detected by the cell voltage sensor 7 becomes no more than a predetermined determination voltage while performing the second current application step, the control device 53 may change so as to increase the current consumption, in the case of changing so as to decrease to a value smaller than the current consumption by the external electrical load of the first current application step (more specifically, a value somewhat, greater than 0).

In the activation method according to the present embodiment, the fuel cell stack 1 is activated by repeatedly executing a plurality of times the above such first current application step and second current application step alternately. At this time, in order to efficiently activate the fuel cell stack 1 in a short time, it is preferable to secure for at least a predetermined time a state in which the fuel cell stack 1 is a hydrogen concentration cell during execution of the second current application step. For this reason, after the state in which the cell average voltage detected by the cell voltage sensor 7 is no more than a predetermined determination voltage while performing the second current application step continued for a predetermined time, it is preferable for the control device 53 to switch the supply of air to the cathode-side gas channel 28 from OFF to ON, and transition from the second current application step to the first current application step. Herein, the determination voltage is a threshold set for the cell average voltage in order to determine that the fuel cell stack 1 became a hydrogen concentration cell, and is set to a value somewhat greater than 0.

According to the activation method and activation apparatus 3 according to the present embodiment, the following effects are exerted.

(1) The activation method according to the present embodiment activates the fuel cell stack 1 by executing a first current application step of electrically connecting both electrodes 25, 26 via the external electric load 6, in a state generating a potential difference between both electrodes 25, 26 by supplying hydrogen gas to the anode electrode 25 and supplying air to the cathode electrode 26, and applying current; and a second current application step of electrically connecting both electrodes via the external electrical load 6 in a state generating a potential difference between both electrodes 25, 26, by supplying hydrogen gas to the anode electrode 25 and supplying nitrogen gas to the cathode electrode 26, and applying current. According to the activation method according to the present embodiment, it is thereby possible to activate the fuel cell stack 1 in a short time while suppressing deterioration of the fuel cell stack 1, compared to a conventional activation method of continuously suppling air to the cathode electrode 26.

Herein, the second current application step can produce a potential difference between both electrodes 25, 26 using the hydrogen concentration difference between the anode electrode 25 supplied hydrogen gas and the cathode electrode 26 supplied nitrogen gas, and makes it possible to perform current application of both electrodes 25, 26 at lower electrical current and smaller supply amounts of anode-side gas and cathode-side gas than during normal power generation, by electrically connecting both electrodes 25, 26 via the external electrical load 6 in a state in which a potential difference occurs in this way. In addition, in the second current application step, since it is possible to supply generated hydrogen produced by electrode reaction by the hydrogen concentration cell to the electrode catalyst and electrolyte membrane included in the anode electrode 25 and cathode electrode 26, it is possible to generate good proton conductivity with the electrolyte membrane 24 in a wet state, and supply to the three-phase interface of the electrode catalyst, electrolyte membrane 24 and hydrogen gas or air, which is the reaction site during power generation of the fuel cell stack 1, and consequently efficiently activate the fuel cell stack 1.

In addition, in the activation method according to the present embodiment, since cross leak from the anode electrode 25 can be suppressed by supplying nitrogen gas in the second current application step, the hydrogen concentration difference can be maintained high, and consequently, a high activation effect can be maintained. In addition, since it is possible to suppress cross leaking in this way with the activation method according to the present embodiment, direct reaction between air and hydrogen can be suppressed, and consequently, deterioration of the fuel cell stack 1 can also be suppressed. Consequently, according to the activation method according to the present embodiment, it is possible to activate the fuel cell stack 1 in a short time compared to a conventional activation method, while suppressing deterioration of the fuel cell stack 1.

(2) By repeatedly performing a plurality of times the first, current application step and second current application step alternately, the activation method according to the present embodiment can rapidly activate a fuel cell compared to the case of performing both steps once each.

(3) In the activation method according to the present embodiment, the first current application step supplies a gas made by mixing air and nitrogen gas to the cathode electrode 26 as cathode-side gas, and turns ON the supply of air while continuing the supply of nitrogen gas, upon transitioning from the first current application step to the second current application step. Therefore, in the activation method according to the present embodiment, since it is possible to repeatedly perform a plurality of times the first current application step and second current application step alternately, by simply alternately repeating ON and OFF of the supply of air, it is possible to activate the fuel cell stack 1 with a simple configuration.

(4) With the activation method according to the present embodiment, by transitioning from the second current application step to the first current application step after a state in which a potential difference between both electrodes 25, 26 is no more than a predetermined determination voltage continued for a predetermined time while performing the second current application step, since it is possible to establish the fuel cell stack 1 as a hydrogen concentration cell over a suitable time, the fuel cell stack 1 can be efficiently activated.

(5) The activation apparatus 3 according to the present embodiment includes the externa, electrical load 6 which electrically connects the anode electrode 25 and cathode electrode 26; and the control device 53 which alternately turns ON or OFF the supply of air to the cathode electrode 26 from the air pump 51 and the cathode-side gas supply path 54 which connects the cathode electrode 26 with the air pump 51 and nitrogen gas supply source 52. According to the activation apparatus 3 according to the present embodiment, by alternately turning ON or OFF the supply of air by the control device 53, since it is thereby possible to repeatedly perform over a plurality of times the first current application step and second current application step alternately, the fuel cell stack 1 can be efficiently activated while suppressing deterioration of the fuel cell stack 1 in the aforementioned way.

(6) The control device 53 in the activation apparatus 3 according to the present embodiment turns ON the supply of air, after a state in which the cell average voltage detecting using the cell voltage sensor 7 has declined to no more than the predetermined determination voltage when turning OFF the supply of air has continued for a predetermined time. Since it is thereby possible to establish the fuel cell stack 1 as a hydrogen concentration cell over an appropriate time, the fuel cell stack 1 can be efficiently activated.

Although an embodiment of the present invention has been explained above, the present invention is not to be limited thereto. The configurations of detailed parts may be modified as appropriate within a scope of the gist of the present invention.

### EXAMPLES

Next, Examples and Comparative Examples of the activation method will be explained. In the following Examples and Comparative Examples, activation was performed with the target of the fuel cell stack 1 assembled by laminating ten of the fuel battery cells 2. In addition, a fuel battery cell including the MEA 21 having a power generation effective area of 100 cm² was used as the fuel battery cell 2.

### Example 1

In Example 1, the activation apparatus 3 was connected to the above-mentioned fuel cell stack 1 of ten cells, and the first current application step and second current application step were repeatedly executed alternately based on the activation method of FIG. 2. At this time, the temperature of the fuel cell stack 1 was kept at 70° C. using the temperature regulation device 3. In addition, in Example 1, hydrogen gas humidified to have a dew point of 70° C. was supplied to the anode-side gas channel 27 as the anode-side gas, using the anode-side gas supply device 4. Herein, the flowrate of hydrogen gas was set: as 0.3 NL/min. In addition, in Example 1, gas made by mixing air and nitrogen gas humidified to have a dew point of 70° C. was supplied to the cathode-side gas channel 28 as the cathode-side gas using the cathode-side gas supply device 5. Herein, the flowrate of air was set to 0.7 NL/min, and the flowrate of nitrogen gas was set to 1.4 NL/min. In addition, in Example 1, by switching the supply of air every 1 minute to ON from OFF or OFF from ON, while continually supplying nitrogen gas at the above such flowrate, the first current application step and second current application step were executed alternately for 1 minute 30 times each. In other words, the time taken in activation of Example 1 is a total of 1 hour. In addition, in the first and second current, application steps, electrical current of 2 A was continued between the electrodes 25, 26, while supplying gas as mentioned above. At this time, the anode-side gas supply device 4 and cathode-side gas supply device 5 supplied anode-side gas and cathode-side gas while performing the first current application step and second current application step, so that the pressure difference between the anode-side gas channel 27 and cathode-side gas channel 28 was maintained at a predetermined value.

### Comparative Example 1

In Comparative Example 1, the activation apparatus 3 was connected to the above-mentioned fuel cell stack 1 of ten cells, and only the first current application step in the activation method of FIG. 2 was executed. At this time, the temperature of the fuel cell stack 1 was kept at 70° C. using the temperature regulation device 3. In Comparative Example 1, the hydrogen gas humidified so as to have a dew point of 70° C. was supplied to the anode-side gas channel 27 as the anode-side gas, using the anode-side gas supply device 4. In addition, in Comparative Example 1, air humidified so as to have a dew point of 70° C. was supplied to the cathode-side gas channel 28 as the cathode-side gas, using the cathode-side gas supply device 5. Herein, the flowrate of hydrogen gas was set to 20 NL/min, the flowrate of air was set to 50 NL/min, and electrical current of 150 A was continued between both electrodes 25, 26 over a total of 1 hour. In the above way, the time performing activation is the same between Comparative Example 1 and Example 1; however, the amount used of hydrogen gas and electrical current are larger in Comparative Example 1 than Example 1. In addition, Comparative Example 1 differs from Example 1 in the point of not including the second current application step.

### Comparative Example 2

In Comparative Example 2, the activation apparatus 3 was connected to the above-mentioned fuel cell stack 1 of ten cells, and only the first current application step in the activation method of FIG. 2 was executed. At this time, the temperature of the fuel cell stack 1 was kept at 70° C. using the temperature regulation device 8. In Comparative Example 2, hydrogen gas humidified to have a dew point of 70° C. was supplied to the anode-side gas channel 27 as the anode-side gas, using the anode-side gas supply device 4. In addition, in Comparative Example 2, air humidified so as to have a dew point of 70° C. was supplied to the cathode-side gas channel 28 as the cathode-side gas, using the cathode-side gas supply device 5. Herein, the flowrate of hydrogen gas was set as 0.3 NL/min, the flowrate of air was set as 0.7 NL/min, and electrical current of 2 A was continued between both electrodes 25, 26 over a total of 1 hour. The time of performing activation in the above way, the amount of hydrogen gas used, and electrical current are the same between Comparative Example 2 and Example 1. In addition. Comparative Example 2 differs from Example 1, in the point of not including the second current application step.

### Comparative Example 3

In Comparative Example 3, the activation apparatus 3 was connected to the above-mentioned fuel cell stack 1 of ten cells, and the activation method disclosed in Japanese Unexamined Patent Application, Publication No. 2010-267455 was reproduced. At this time, the temperature of the fuel cell stack 1 was kept at 70° C. using the temperature regulation device 8. In Comparative Example 3, hydrogen gas humidified to have a dew point of 70° C. was supplied to the anode-side gas channel 27 as the anode-side gas, using the anode-side gas supply device 4. Herein, the flowrate of hydrogen gas was set as 0.3 NL/min. In addition, in Comparative Example 3, air humidified so as to have a dew point of 70° C. was supplied to the cathode-side gas channel 23 as the cathode-side gas, using the cathode-side gas supply device 5. In addition, in Comparative Example 3, the supply of air was switched from ON to OFF, or OFF to ON every 1 minute. Herein, the flowrate of air while setting the supply of air to ON was set to 0.7 NL/min. In addition, in Comparative Example 3, the step turning ON the supply of air and the step turning OFF the supply of air in this way are executed alternately for 1 minute each for 30 times. In other words, the time taken in activation of Comparative Example 3 is a total of 1 hour. In addition, in Comparative Example 3, electrical current of 2 A was continued between the electrodes 25, 26, while supplying gas as mentioned above. The time for which performing activation in the above way, the amount of hydrogen gas used, and electrical current are the same between Comparative Example 3 and Example 1. In addition, Comparative Example 3 differs from Example 1 in the point of not supplying nitrogen gas while turning OFF the supply of air.

Next, the performance of the fuel cell stack activated by the activation methods of the above such Example 1 and Comparative Examples 1 to 3 will be explained while referencing Table 1 below. Table 1 is a view comparing the magnitude of voltage when drawing electrical, current of 150 A from the fuel cell stack activated by the activation methods of Example 1 and Comparative Examples 1 to 3. In addition. Table 1 below shows a case of setting the voltage of the fuel cell stack as “1” after activating by the activation method of Comparative Example 2.

TABLE 1

| | VOLTAGE @ |
|---|---|
| | 150 [A] |
| EXAMPLE 1 | 1.64 |
| COMPARATIVE EXAMPLE 1 | 1.49 |
| COMPARATIVE EXAMPLE 2 | 1.00 |
| COMPARATIVE EXAMPLE 3 | 1.10 |

As listed in Table 1 above, the voltage of the fuel cell stack after activation was higher in the order of Comparative Example 2, Comparative Example 3, Comparative Example 1 and Example 1. The time for which performing activation in the aforementioned way is the same in Example 1 and Comparative Examples 1 to 3. Therefore, the activation method of Example 1 is considered to be able to activate the fuel cell stack efficiently in a shorter time than the activation method of Comparative Examples 1 to 3. In addition, when comparing Comparative Example 1 and Example 1 in the aforementioned way, the amount used of hydrogen gas and electrical current, were greater for Comparative Example 1. Therefore, according to the activation method of Example 1, it is considered to be able to activate the fuel cell stack efficiently with lower cost than Comparative Examples 1 to 3.

In addition, when comparing Comparative Example 3 and Example 1 in the above way, the activation method of Comparative Example 3 differs from the activation method of Example 1 in the point of not supplying nitrogen gas while turning OFF the supply of air. For this reason, with the activation method of Comparative Example 3, hydrogen will cross leak from the anode electrode to the cathode electrode while turning OFF the supply of air, and the potential difference between tooth electrodes will become smaller. For this reason, according to the activation method of Example 1, it is possible to activate the fuel cell stack efficiently in a shorter time than the activation method of Comparative Example 3. In addition, with the activation method of Comparative Example 3, when switching the supply of air from OFF to ON, there is a risk of the hydrogen remaining in the cathode electrode and oxygen in the newly supplied air directly reacting, and the fuel cell stack deteriorating by heat generation. In contrast, since the activation method of Example 1 continuously supplies nitrogen gas also while turning OFF the supply of air, the cross leak of hydrogen is small, and consequently it is possible to suppress deterioration of the fuel cell stack.

### Example 2

In Example 2, the time for which performing activation is defined as 1 hour the same as Example 1, and the frequency of repeatedly performing the first current application step and second current application step alternately (repeating frequency), and the time (interval time) executing the first current application step or second current application step are changed as described in Table 2 below. Example 2-1 establishes the repeating frequency as 2 (times), and interval time as 15 (min), Example 2-2 establishes the repeating frequency as 5 (times) and interval time as 5 (min), Example 2-3 establishes the repeating frequency as 10 (times) and interval time as 3 (min), and Example 2-4 establishes the repeating frequency as 60 (times) and interval time as 0.5 (min).

TABLE 2

| | REPEATED | | ACTI- | VOLT- |
|---|---|---|---|---|
| | NUMBER | | VATION | AGE |
| | OF TIMES | INTERVAL | TIME | @ |
| | [TIMES] | [MINUTES] | [HOUR] | 150 [A] |
| COMPAR - | 1 | 30 | 1 | 1.38 |
| ATIVE | | | | |
| EXAMPLES 3 | | | | |
| EXAMPLE 2-1 | 2 | 15 | 1 | 1.42 |
| EXMAPLE 2-2 | 5 | 6 | 1 | 1.48 |
| EXAMPLE 2-3 | 10 | 3 | 1 | 1.55 |
| EXAMPLE 1 | 30 | 1 | 1 | 1.64 |
| EXAMPLE 2-4 | 60 | 0.5 | 1 | 1.54 |

As described in Table 2 above, the voltage of the fuel cell stack after activation is higher in the order of Comparative Example 3, Example 2-1, Example 2-2, Example 2-4, Example 2-3 and Example 1. In ether words, speaking of the fuel cell stack 1 of ten cells adopted this time, it is considered possible to most efficiently activate the fuel cell stack by setting the repeating frequency as 30. According to the above, the activation method of the present invention can activate the fuel cell stack efficiently in a short time by adjusting the repeating frequency according to the specification of the fuel cell stack trying to be activated.

### Example 3

Example 3 establishes the time for executing the first current application step or second current application step (Interval time as 1 (min) the same as Example 1, and changes the time for which performing activation and the frequency of repeatedly performing the first current application step and second current application step alternately (repeating frequency) as in Table 3 below. Example 3-1 establishes the repeating frequency as 10 (times) and the activation time as ⅓ (hour), Example 3-2 establishes the repeating frequency as 20 (times), and the activation time as ⅔ (hour), Example 3-3 establishes the repeating frequency as 60 (times) and the activation time as 2 (hours), and Example 3-4 establishes the repeating frequency as 90 (times) and the activation time as 3 (hours).

TABLE 3

| | REPEATED | | ACTI- | |
|---|---|---|---|---|
| | NUMBER | | VATION | VOLT- |
| | OF TIMES | INTERVAL | TIME | AGE @ |
| | [TIMES] | [MINUTES] | [HOUR] | 150 [A] |
| EXAMPLE 3-1 | 10 | 1 | ⅓ | 1.10 |
| EXAMPLE 3-2 | 20 | 1 | ⅔ | 1.53 |
| EXAMPLE 1 | 30 | 1 | 1 | 1.64 |
| EXAMPLE 3-3 | 60 | 1 | 2 | 1.70 |
| EXAMPLE 3-4 | 90 | 1 | 3 | 1.75 |

As described in Table 3 above, the voltage of the fuel cell stack after activation is higher in the order of Example 3-1, Example 3-2, Example 1, Example 3-3, and Example 3-4. In other, words, the activation method according to the present invention can activate the fuel cell stack more as the repeating frequency is increased and the activation time is lengthened; however, the efficiency thereof is considered to decline as increasing the repeating frequency and lengthening the activation time.

### Example 4

Example 4 establishes the activation time, repeating frequency and interval time to be the same as Example 1, and changes the flowrate of air in the second current application step as in Table 4 below. Example 4-1 establishes the flowrate of air in the second current application step as 0.20 (NL/rain), Example 4-2 establishes the flowrate of air in the second current application step as 0.37 (NL/min), Example 4-3 establishes the flowrate of air in the second current application step as 0.40 (NL/min), and Example 4-4 establishes the flowrate of air in the second current application step as 0.50 (NL/min). It should be noted that the flowrate of gas such as hydrogen gas and nitrogen gas other than the flowrate of air in the second current application step are all the same as Example 1. In addition, the stoichiometric ratio of air in the second current application step becomes 0.6 in Example 4-1, 1.12 in Example 4-2, 1.21 in Example 4-3, and 1.51 in Example 4-4. Herein, stoichiometric ratio of air in the second current application step refers to the ratio of the flowrate of air in the second current application step relative to the theoretical flowrate of air required in order to perform normal power generation in the fuel cell stack 1, while supplying hydrogen gas to the anode-side gas channel 27 (flowrate of air in second current application step/theorectial flowrate of air)

TABLE 4

| | STOICHIOMETRIC | FLOWRATE | |
|---|---|---|---|
| | RATIO OF AIR IN | OF AIR IN | |
| | SECOND | SECOND | VOLT - |
| | CURRENT | CURRENT | AGE |
| | APPLICATION | APPLICATION | @ |
| | STEP | STEP [NL/min] | 150 [A] |
| EXAMPLE 1 | 0 | 0 | 1.64 |
| EXAMPLE 4-1 | 0.6 | 0.20 | 1.53 |
| EXAMPLE 4-2 | 1.12 | 0.37 | 1.48 |
| EXAMPLE 4-3 | 1.21 | 0.40 | 1.1 |
| EXAMPLE 4-4 | 1.51 | 0.50 | 1 |

As described in Table 4 above, the voltage of the fuel cell stack after activation is higher in the order of Example 4-4, Example 4-3, Example 4-2, Example 4-1 and Example 1. In other words, the activation method according to the present invention is considered to more efficiently activate in a shorter time as lowering the flowrate of air in the second current application step, i.e. as lowering the flowrate ratio of air to nitrogen gas in the cathode-side gas supplied to the cathode-side gas channel 23 in the second current, application step (flowrate of air/flowrate of nitrogen gas). According to the results of Table 4 above, a particularly large difference is recognized in the effect of activation between Example 4-2 and Example 4-3. For example, the flowrate of air supplied to the cathode-side gas channel 23 in the second current application step is considered preferably set as smaller than the flowrate of air supplied to the cathode-side gas channel 28 in the first current application step, and the stoichiometric ratio is set to no more than 1.12.

### Example 5

Example 5 establishes the activation time, repeating frequency, interval time and flowrate of various gases as the same as Example 1, and changes the combination of the temperature of the fuel cell stack (stack temperature), dew point of anode-side gas (anode dew point), and dew point of cathode-side gas (cathode dew point) as described in Table 5 below. Example 5-1 establishes the stack temperature as 50° C. anode dew point as 50° C. and cathode dev; point as 50° C., Example 5-2 establishes the stack temperature as 50° C., anode dew point as 70° C. and cathode dew point as 70° C., Example 5-3 establishes the stack temperature as 70° C., anode dew point as 60° C. and cathode dew point as 70° C., Example 5-4 establishes the stack temperature as 70° C., anode dew point as 70° C. and cathode dew point as 80° C., Example 5-5 establishes the stack temperature as 70° C., anode dew point as 80° C. and cathode dew point as 30° C., Example 5-6 establishes the stack temperature as 80° C., anode dew point as 80° C. and cathode dew point as 80° C., and Example 5-7 establishes the stack temperature as 80° C., anode dew point as 70° C. and cathode dew point as 70° C.

TABLE 5

| | STACK | ANODE | CATHODE | VOLT- |
|---|---|---|---|---|
| | TEMPER- | DEW | DEW | AGE |
| | ATURE | POINT | POINT | @ |
| | [° C.] | [° C.] | [° C.] | 150 [A] |
| EXAMPLE 5-1 | 50 | 50 | 50 | 1.10 |
| EXAMPLE 5-2 | 50 | 70 | 70 | 1.53 |
| EXAMPLE 1 | 70 | 70 | 70 | 1.64 |
| EXAMPLE 5-3 | 70 | 60 | 70 | 1.63 |
| EXAMPLE 5-4 | 70 | 70 | 60 | 1.64 |
| EXAMPLE 5-5 | 70 | 80 | 80 | 1.69 |
| EXAMPLE 5-6 | 80 | 80 | 80 | 1.67 |
| EXAMPLE 5-7 | 80 | 70 | 70 | 1.60 |

As described in Table 5 above, the voltage of the fuel cell stack after activation is higher in the order of Example 5-1, Example 5-2, Example 5-7, Example 5-3, Example 1, Example 5-4, Example 5-6 and Example 5-5. According to the results of Table 5 above, a particularly large difference is recognized in the effect of activation between Example 5-1 and Example 5-2. For this reason, the dew point of the anode-side gas is preferably higher than 50° C., and the dew point of the cathode-side gas is preferably higher than 50° C. According to the above, the activation method of the present invention can activate the fuel cell stack efficiently in a short time by adjusting the stack temperature, anode dew point and cathode dew point according to the specification of the fuel cell stack trying to be activated.

### EXPLANATION OF REFERENCE NUMERALS

1 fuel cell stack (fuel cell)
2 fuel battery cell (fuel cell)
24 electrolyte membrane
25 anode electrode
26 cathode electrode
3 activation apparatus
4 anode-side gas supply device
41 hydrogen gas supply source
42 hydrogen supply path (anode-side gas supply path)
5 cathode-side gas supply device
51 air pump (oxidizer gas supply source)
52 nitrogen gas supply source (inert gas supply source)
53 control device (switching means)
54 cathode-side gas supply path (cathode-side gas supply path)
6 external electrical load (external electrical load)
7 cell voltage sensor (voltage sensor)

1. An activation method for a fuel cell that includes an electrolyte layer containing solid polymer, an anode electrode provided to one surface of the electrolyte layer, and a cathode electrode provided to another surface of the electrolyte layer, the activation method comprising:
a first current application step of electrically connecting the anode electrode and the cathode electrode via an external electrical load to apply current, in a some of generating a potential difference between the anode electrode and the cathode electrode, by supplying hydrogen gas as anode-side gas to the anode electrode and supplying oxidizer gas as cathode-side gas to the cathode electrode; and
a second current application step of electrically connecting the anode electrode and the cathode electrode via the external electrical load to apply current, in a state of generating a potential difference between the anode electrode and the cathode electrode, by supplying hydrogen gas as anode-side gas to the anode electrode and supplying inert gas as cathode-side gas to the cathode electrode.

2. An activation method for a fuel cell according to claim 1, the activation method repeatedly performing, a plurality of times the first current application step and the second current application step alternately.

3. An activation method for a fuel cell according to claim wherein the first current application step supplies a mixture mixing oxidizer gas and inert gas to the cathode electrode as cathode-side gas, and
wherein supply of oxidizer gas is turned OFF while continuing supply of inert gas when transitioning from the first current application step to the second current application step.

4. An activation method for a fuel cell according to claim 1, wherein after a state in which a potential difference between the anode electrode and the cathode electrode is no more than a predetermined voltage continues for a predetermined time while performing the second current application step, the second current application step is transitioned to the first current application step.

5. An activation apparatus for a fuel cell that includes an electrolyte layer containing solid polymer, an anode electrode provided tog one surface of the electrolyte layer, and a cathode electrode provided to another surface of the electrolyte layer, the activation apparatus comprising:
an external electrical load which electrically connects the anode electrode and the cathode electrode;
a hydrogen gas supply source which supplies hydrogen gas;
an anode-side gas supply path which connects the anode electrode and the hydrogen gas supply source;
an oxidizer gas supply source which supplies oxidizer gas;
are inert gas supply source which supplies inert gas;
a cathode-side gas supply path which connects the cathode electrode with the oxidizer gas supply source and the inert gas supply source; and
a control means which alternately turns ON or OFF supply of oxidizer gas from the oxidizer gas supply source to the cathode electrode.

6. The activation apparatus for a fuel cell according to claim 5, further comprising a voltage sensor which detects a potential difference between the anode electrode and the cathode electrode,
wherein the control means which turns ON supply of the oxidizer gas, after a state in which the potential difference when turning OFF supply of the oxidizer gas declined tee no more than a predetermined voltage has continued for a predetermined time.

7. An activation method for a fuel cell according to claim 2, wherein the first current application step supplies a mixture mixing oxidizer gas and inert gas to the cathode electrode as cathode-side gas, and
wherein supply of oxidizer gas is turned OFF while continuing supply of inert gas when transitioning from the first current application step to the second current application step.

8. An activation method for a fuel cell according to claim 2, wherein after a state in which a potential difference between the anode electrode and the cathode electrode is no more than a predetermined voltage continues for a predetermined time while performing the second current application step, the second current application step is transitioned to the first current application step.

9. An activation method for a fuel cell according to claim 3, wherein after a state in which a potential difference between the anode electrode and the cathode electrode is no more than a predetermined voltage continues for a predetermined time while performing the second current application step, the second current application step is transitioned to the first current application step.

10. An activation method for a fuel cell according to claim 7, wherein after a state in which a potential difference between the anode electrode and the cathode electrode is no more than a predetermined voltage continues for a predetermined time while performing the second current application step, the second current application step is transitioned to the first current application step.
